(19) United States
(12) Patent Application Publication
(10) Pub. No.: US 2012/0274106 A1
(43) Pub. Date: Nov. 1, 2012

(54) Device for Suspending Objects

(76) Inventors: Peter Ackeret, Zurich (CH); Juergen Siegfried Skott, Altensteig (DE)

(21) Appl. No.: 13/508,046

(22) PCT Filed: Nov. 2, 2010
(86) PCT No.: PCT/EP10/06662

§ 371 Date: Jul. 9, 2012

(30) Foreign Application Priority Data
Nov. 5, 2009 (DE) 10 2009 052 115.1
Mar. 15, 2010 (DE) 10 2010 011 532.0
Sep. 22, 2010 (DE) 10 2010 048 035.5

(51) Int. Cl. B60R 7/04

(52) U.S. Cl. 297/188.01

(57) ABSTRACT

A device for suspending objects which can be mounted on vehicle seats comprises a fastening means (105, 106) for connecting the device to the vehicle seat part, with a receiving bush (102a, 102f), a plug element (103a) which can be coupled to the receiving bush (102a, 102f), a locking mechanism for locking the plug element (103a) in the receiving bush (102a, 102f) in the receiving bush (102a, 102f), and a carrier arm for suspending the objects, wherein the locking mechanism and the carrier arm are arranged on the plug element (103a), and wherein the plug element (103a) comprises a housing which at least partially encloses the locking mechanism and the carrier arm.

The invention relates to a device for suspending objects on a vehicle seat part, such as a backrest, head restraint or head restraint bars of a vehicle seat.

Frequently there is a need to secure objects transported in vehicles in such a way that they can neither slip, tilt over nor fall from the seat during a journey in the vehicle. This can be a particular nuisance in the case of shopping bags in which many different types of delicate foodstuffs are often transported. Handbags also often contain many smaller objects, which may be tossed around when the handbag tilts over in the vehicle and thus be damaged or become lost beneath the seats. Frequently, notebook computers are transported in bags in the vehicle, which, on sudden car maneuvers, may be hurled through the vehicle and become damaged or injure passengers.

On journeys, items of clothing hung on one or more clothes hangers, often also packed in clothes bags, are also frequently placed on the front or back passenger seats, which slip down from the seat and fall to the floor even on minor accelerations because of the slippery material, so that the clothes become soiled and creased. For that reason, clothes on clothes hangers or in clothes bags are often also hung up on the hand grips disposed laterally above the doors, where they, however, impede the view of the driver in a dangerous way and can impede access to the rear seats.

During shorter journeys, a jacket is frequently hung from one of the hooks commonly found in vehicles disposed above the door and often combined with the hand grip, which can also impede the view of the driver and impede access into or out of the vehicle.

The object of the invention is to create a device for suspending objects, which can be mounted on vehicle seats and on which objects such as shopping bags and handbags, jackets and clothes, either loose or on clothes hangers and in clothes bags, can be secured in a simple and rapid manner against slipping, tilting over or falling from the seat without thereby impeding the view of the driver and impeding access into or out of the vehicle.

Moreover, the device should be constituted in such a way that, when not in use, it occupies as little space as possible and does not pose any risk of injury to the passengers of the vehicle. In addition, it should be possible to mount and remove the device from vehicle seats and replace it with other devices in a simple and rapid manner.

This object is inventively achieved with a device for suspending objects on a vehicle seat part, such as a backrest, head restraint or head restraint bars of a vehicle seat with the characteristics of independent claim 1.

Advantageous embodiments of the invention are defined in the dependent claims.

The inventive device comprises a fastening means for connecting the device to the vehicle seat part, with a receiving bush and a plug element which can be coupled to the receiving bush, as well as a locking mechanism for locking the plug element in the receiving bush and a carrier arm for suspending the objects, wherein the locking mechanism and the carrier arm are arranged on the plug element, and wherein the plug element comprises a housing which at least partially encloses the locking mechanism and the carrier arm.

The fastening means is preferably constituted in such a way that the device can be connected to the vehicle seat part from the front and from the rear. Particularly suitable is a fastening means in the space between the top of the backrest and the bottom of the head restraint. In this way, for example, bags or clothes hangers can be suspended on vacant front or back passenger seats from the carrier arm on the front side of the backrest facing the seat bench.

The carrier arm can be connected to the plug element such that it is rigid or movable. If the connection is movable, the carrier arm occupies less space when the device is not in use, however, the design is considerably more complex to achieve a high bearing strength.

In a preferred embodiment, the carrier arm is rigidly connected to the plug element and in combination with the latter forms a robust component which, when not in use or if it would restrict or pose a danger to passengers, can be removed from the fastening means in a simple and rapid manner by releasing the locking mechanism, and can be reconnected to the fastening means in an equally simple and rapid manner when needed again.

The assignment of the locking mechanism to the plug element permits a very robust connection between the plug element and the fastening means and optimum accessibility for releasing the locking mechanism quickly.

A rigid connection between the plug element and the carrier arm permits a greatly simplified design and an improvement in the stability over the movable connection and has the advantage that the device is ready for use at any time and can be operated with one hand.

In a preferred embodiment, the plug element comprises a housing, which at least partially encloses the locking mechanism and the carrier arm, so that no danger to the passengers arises and the device is also aesthetically pleasing.

The carrier arm is preferably made of metal and is surrounded by two housing shells which are plugged on from the side and join in the middle. This produces a very stable design that is optimal in terms of safety and aesthetics. Moreover in this way, a robust and easy to handle locking mechanism can be accommodated in the plug element.

In a preferred embodiment, the plug element, the carrier arm and the housing jointly form an approximately cuboid body, whose height approximately corresponds to the height of the fastening means, so that the device can be accommodated in the space between the top of the backrest and the bottom of the head restraint.

Further preferred embodiments of the invention result from the remaining characteristics stated in the dependent claims.

It is understood that the characteristics stated above and below can be used not only in the stated combination but also in other combinations or alone without departing from the scope of this invention.

The invention is explained in more detail below in examples based on the relevant drawings.

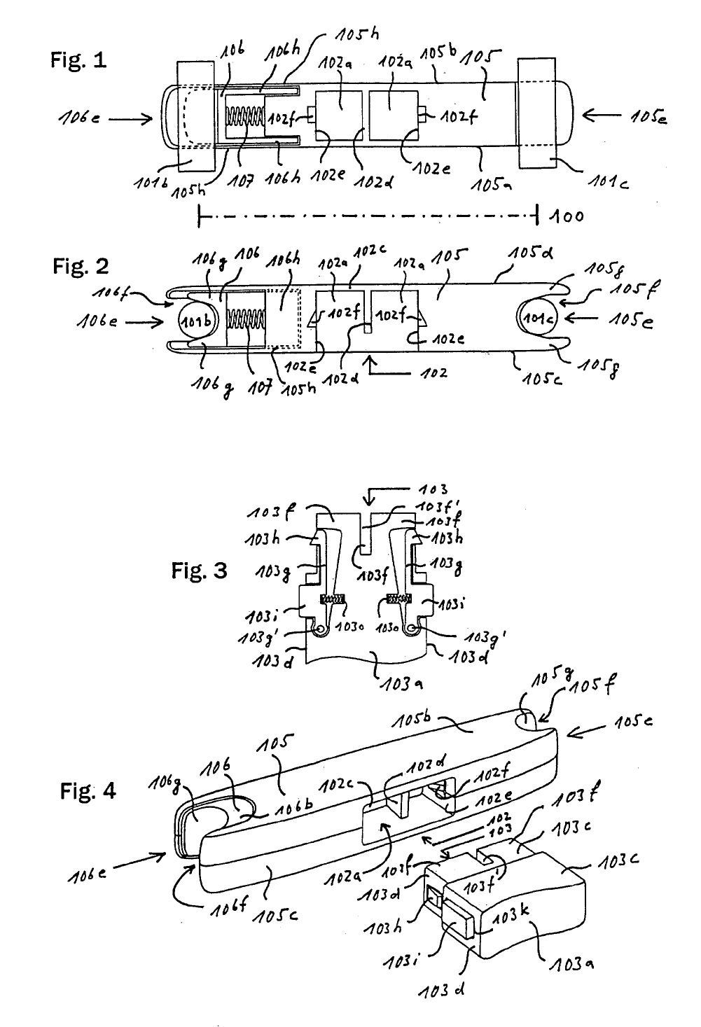

FIG. 1 shows a longitudinal section from the side of a first variant of a fastening means, mounted on two head restraint bars.

FIG. 2 shows a longitudinal cross-section of the fastening means according to FIG. 1 from above.

FIG. 3 shows a plug element of the fastening means according to FIG. 1 and FIG. 2 in a longitudinal section from above.

FIG. 4 shows a perspective view of the fastening means according to FIG. 1 and FIG. 2 with the plug element according to FIG. 3 when not mounted.

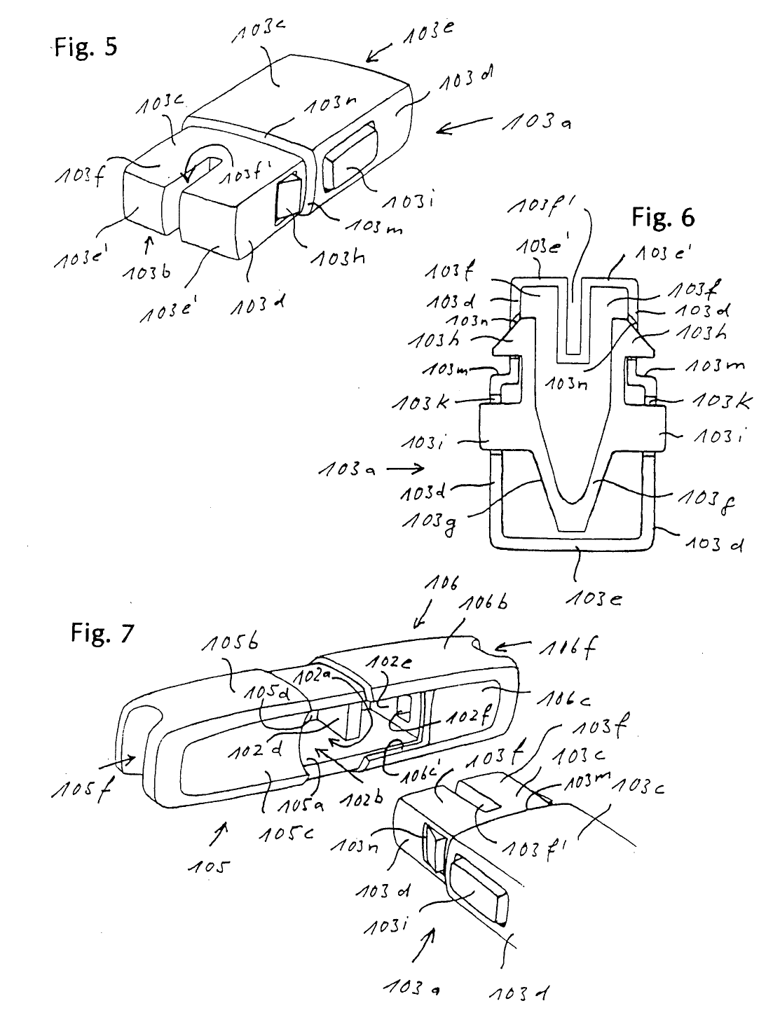

FIG. 5 shows a perspective view of a variant of the plug element.

FIG. 6 shows a longitudinal section through the plug element according to FIG. 5 from above.

FIG. 7 shows a perspective view of a second variant of the fastening means with plug element according to FIG. 5.

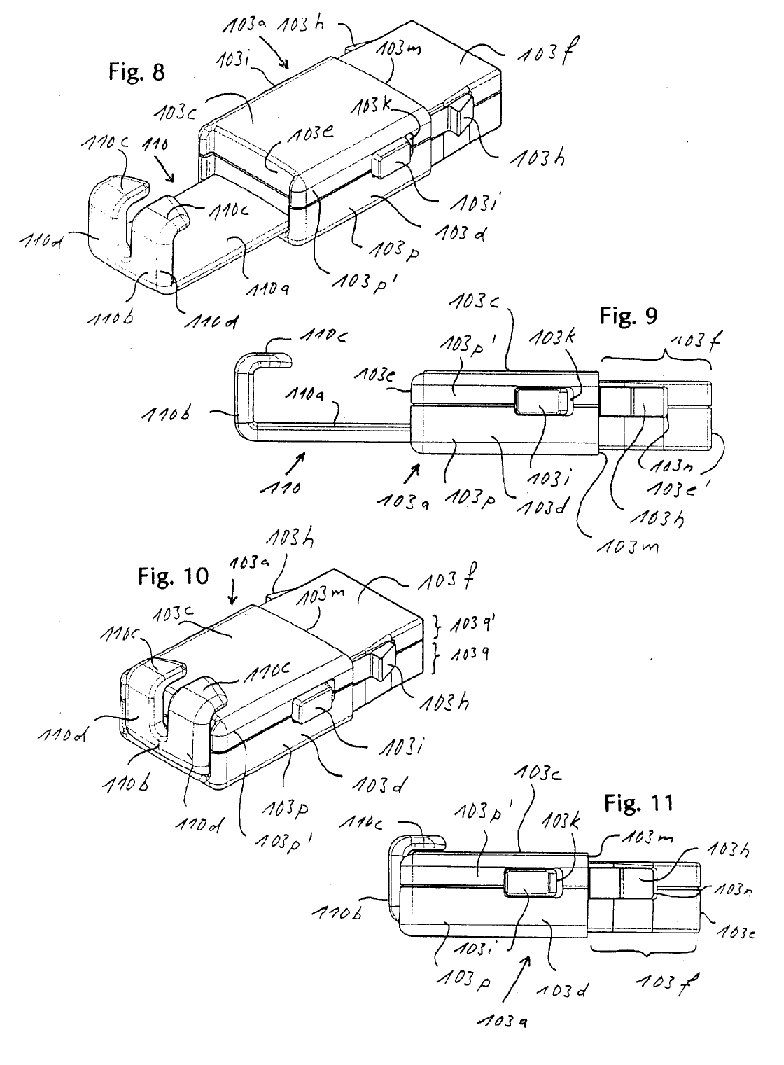

FIG. 8 shows a perspective view of a first variant of the plug element with integrated carrier arm in the working position.

FIG. 9 shows a side view of the plug element according to FIG. 8 with the carrier arm in the working position.

FIG. 10 shows a perspective view of the plug element according to FIG. 8 and FIG. 9 with the carrier arm in the non-working position.

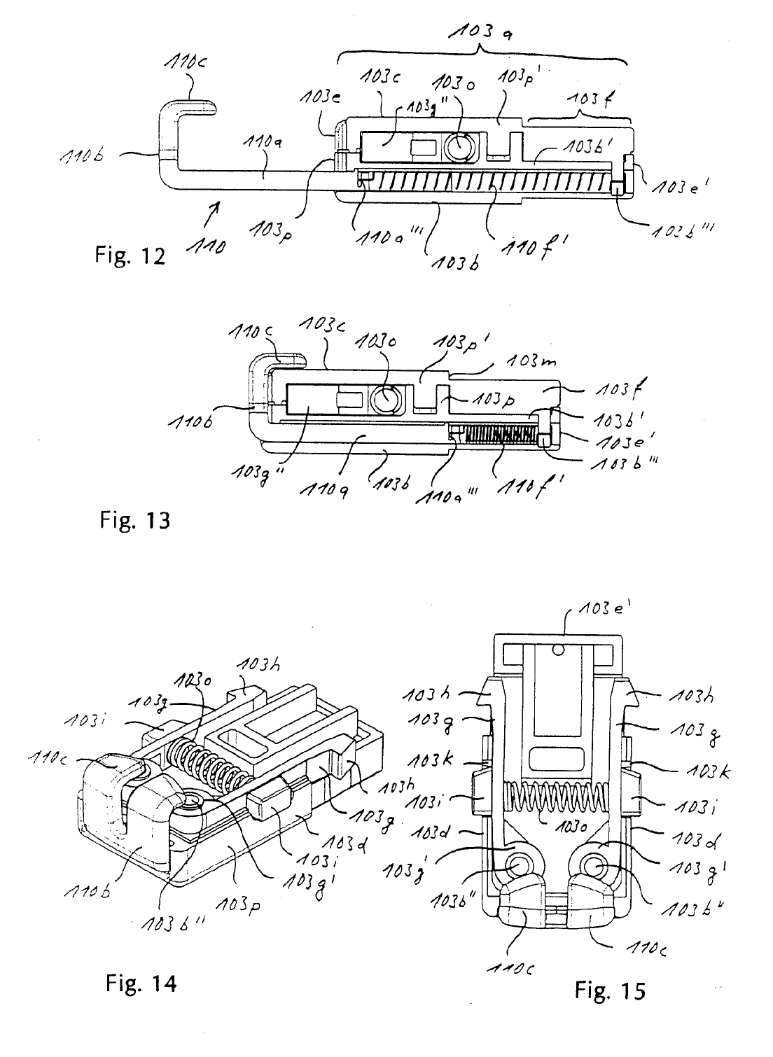

FIG. 11 shows a side view of the plug element according to FIG. 10 with the carrier arm in the non-working position.

FIG. 12 shows a longitudinal section of the plug element according to FIG. 8 and FIG. 9 with the carrier arm in the working position.

FIG. 13 shows a longitudinal section of the plug element according to FIG. 10 and FIG. 11 with the carrier arm in the non-working position.

FIG. 14 shows a perspective interior view of the plug element according to FIG. 13.

FIG. 15 shows an interior view from above of the plug element according to FIG. 13.

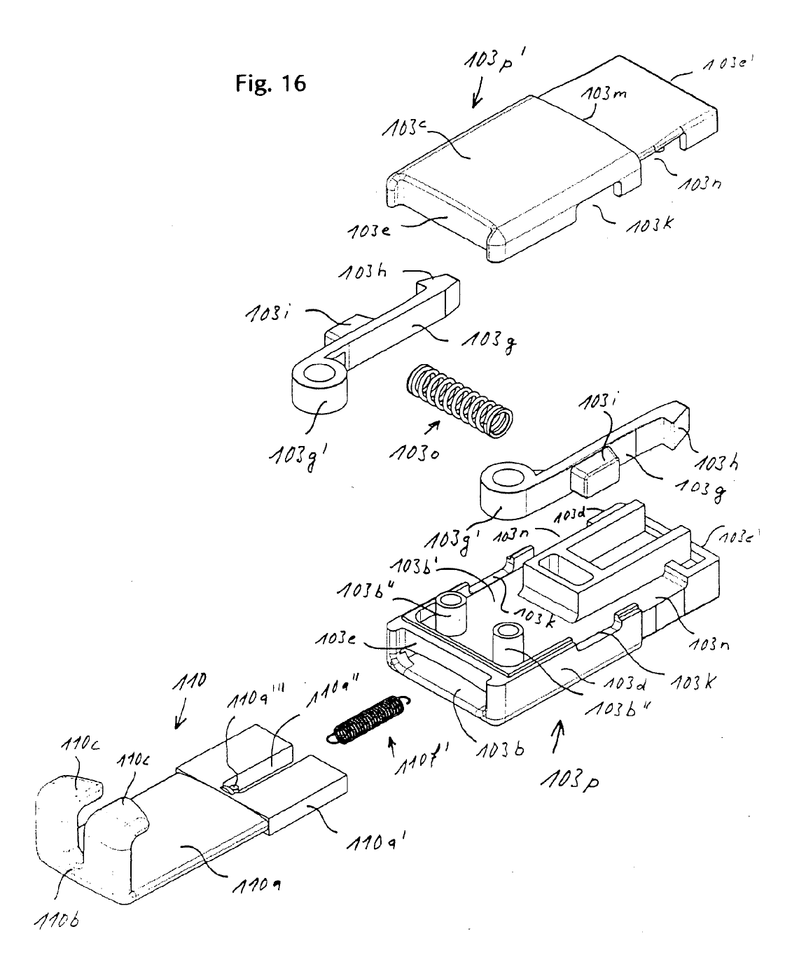

FIG. 16 shows an exploded view of the plug element according to FIG. 8 to FIG. 15.

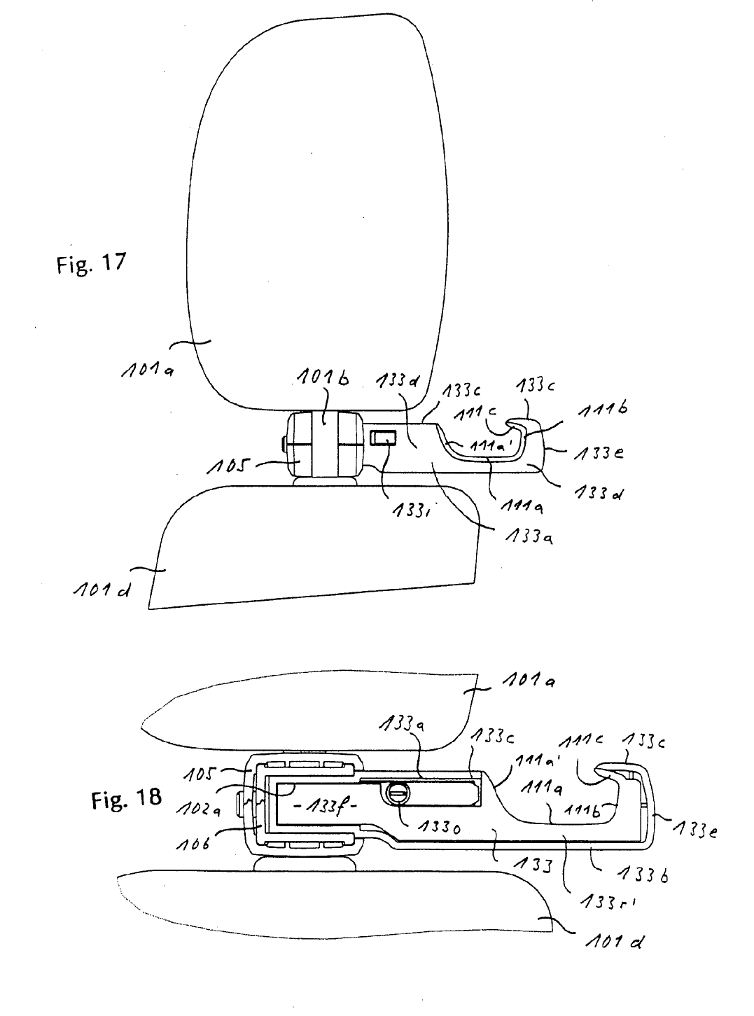

FIG. 17 shows a side view of a second variant of the plug element with integrated carrier arm, mounted together with the fastening means acc. to FIG. 7 on a vehicle seat

FIG. 18 shows a longitudinal section through the plug element with integrated carrier arm and the fastening means according to FIG. 17.

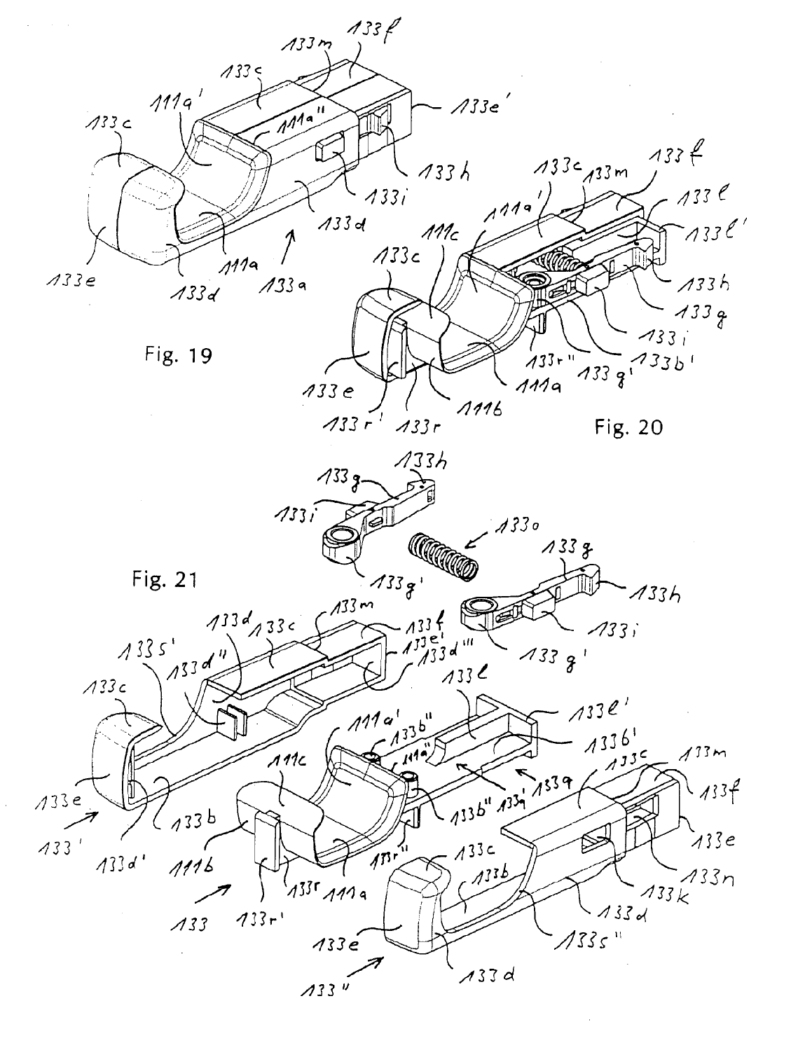

FIG. 19 shows a perspective view of the plug element with integrated carrier arm according to FIG. 17 and FIG. 18

FIG. 20 shows a partially cut-out perspective view of the plug element with integrated carrier arm according to FIG. 19.

FIG. 21 shows an exploded view of the plug element with integrated carrier arm according to FIG. 19 and FIG. 20.

FIGS. 1 to 4 show a first variant of the fastening means 105, 106. The first fastening element 105 comprises a longitudinal housing in the form of a rectangular parallelepiped with a bottom wall 105a, a top wall 105b, a front side wall 105c and a rear side wall 105d.

A receiving bush 102a is disposed approximately in the centre of the housing of the first fastening element 105, said receiving bush 102a having an opening 102b in the front side wall 105c, into which a guide section 103f of a plug element 103a can be inserted. To stabilize the receiving bush 102a, a guide web 102d is disposed centrally in the rear wall 102c. With said guide web 102d, a recess 103f′ disposed on the plug element 103a engages when the plug element 103a is plugged into the receiving bush.

On the plug element 103a, spring arms 103g are disposed on both sides of the guide section 103f, supported at joints 103g′ and spring-preloaded against each other with springs 103o, locking hooks 103h being disposed on their front ends, which engage in the corresponding recesses 102f on the side walls 102e of receiving bush 102a and lock the plug element 103a in the receiving bush 102a.

Actuating members 103i that point outward are disposed on both spring arms 103g between the locking hooks 103h and the joints 103g′, said actuating members 103i protruding from the plug element 103a through switch openings 103k in the side walls 103d. To release the lock, the two actuating members 103i are pressed together and the guide section 103f of the plug element 103a is pulled out of the receiving bush 102a.

The second fastening element 106 is guided by means of linear guides 105h, 106h in the first fastening element 105 and can be moved parallel to an approximately horizontally extending connection line 100 between the centers of the head restraint bars 101b, 101c relative to the first fastening element 105. The second fastening element 106 is pressed toward the head restraint bar 101b with the clamping spring 107.

Fork-shaped recesses 105f, 106f are disposed on the outside ends 105e, 106e of the first fastening element 105 and of the second fastening element 106, which receive the head restraint bars 101b, 101c. The legs 105g, 106g of the fork-shaped recesses 105f, 106f open out in a V-shape in the direction of the head restraint bars 101b, 101c, so that head restraint bars 101b, 101c of varying diameters bear against the legs 105g, 106g approximately tangentially.

FIGS. 5 to 7 show a second variant of the fastening means 105, 106 with a variant of the plug element 103a. The bottom wall 103b, the top wall 103c, and the side walls 103d which form the housing of the plug element 103a, extend forward beyond the two locking hooks 103h and terminate with the end wall 103e′, so that the plug element 103a is a housing closed from all sides.

The bottom wall 103b, the side walls 103d and the top wall 103c on the guide section 103f of plug element 103a accommodated in the receiving bush 102a are slightly set back, so that a step 103m is formed all round, which forms a limit stop to limit the insertion depth of the plug element 103a into the receiving bush 102a as well as a counter stop for the locking hooks 103h. Openings 103n through which the locking hooks 103h protrude through the housing as well as switch openings 103k for the actuating members 103i are provided in the side walls 103d.

A guide web 102d is provided in the receiving bush 102a, which connects the bottom wall 105a, the rear side wall 105d and the top wall 105b of the first fastening element 105 and increases the stability of the receiving bush 102a and ensures that the guide section 103f is centered without play. A complementary recess 103f′ for accommodating the guide web 102d is provided in guide section 103f of the plug element 103a.

FIGS. 8 to 16 show a first variant of the plug element 103a with an integrated carrier arm 110. The plug element 103a comprises a housing lower section 103p with a bottom wall 103b, an intermediate wall 103b′ and parts of the two side walls 103d, as well as the rear end wall 103e and the front end wall 103e′ and a lid 103p′ with the top wall 103c and parts of the two side walls 103d as well as the rear end wall 103e and the front end wall 103e. For easier accessibility during mounting, the lower housing part 103p is composed of two parts, having a separate bottom wall 103b.

The intermediate floor 103b′ divides the plug element 103a into two receiving spaces 103q, 103q′ (FIG. 16) which lie one on top of the other. The linearly extendible carrier arm 110 with the guide section 110a′ and the tension spring 110f′ for retracting in the carrier arm 110a into the receiving space 103q are accommodated in the lower receiving space 103q, and the locking mechanism 103g, 103g′, 103h, 103i, 103o, 103b″ of the plug element 103a is accommodated in the upper receiving space 103q′. Both receiving spaces 103q, 103q′ essentially extend along the entire length of the plug element 103a including the guide section 103f, which is inserted into the receiving bush 102a of the first fastening element 105. This makes a long guide and extension length available for the carrier arm 110, without the length of the plug element 103a having to be enlarged beyond the length required for the locking mechanism 103g, 103g′, 103h, 103i, 103o, 103b″.

The carrier arm 110 can be moved between a non-working position in which it is essentially accommodated in the receiving space 103q (FIGS. 10, 11, 13) and a working position (FIGS. 8, 9, 12) in which it protrudes beyond the backrest 101d of the vehicle seat 101 in order to suspend objects, such as, for example, bags, cases, clothes hangers.

The carrier arm 110 comprises a bottom wall 110a with a guide section 110a′ at the rear end of the bottom wall 110a as well as an approximately vertically extending terminating wall 110b disposed at the front end of the bottom wall 110a, a holding device 110c being disposed at the top end of said terminating wall 110b extending approximately parallel with the bottom wall 110a and facing toward the plug element 103a. The terminating wall 110b and the holding device 110c have a slit at the center so that both sections 110d can be used as clothes hooks both in the working position and in the non-working position of the carrier arm 110.

The bottom wall 110a of the carrier arm 110 is guided such that it can be linearly moved along the bottom wall 103b of the plug element 103a together with the guide section 110a′, which also forms the limit stop to limit the extension path, wherein the direction of movement is parallel to the insertion direction of the plug element 103a into the receiving bush 102a.

In the center of the guide section 110a, a spring cutout 110a″ with a first spring suspension 110a′″ is provided, to which one end of the tension spring 110f′ is attached, whose other end is attached to a second spring suspension 103b″ disposed on the intermediate floor 103b′. The tension spring retracts the carrier arm 110 back into the receiving space 103q when the carrier arm 110 is not in use.

The locking mechanism 103g, 103g′, 103h, 103i, 103o, 103b″ of the plug element 103a accommodated in the upper receiving space 103q′ comprises the two spring arms 103g on whose rear ends bearing eyes 103g′ are disposed, with which the spring arms 103g are rotatably located on bearing journals 103b″, which are disposed on the intermediate floor 103b′.

The locking hooks 103h, which protrude through the openings 103n in the side walls 103d, are disposed on the front ends of the spring arms 103g. Actuating members 103i, which protrude through switch openings 103k in the side walls 103d, are disposed on the spring arms 103g approximately centrally between the locking hooks 103h and the bearing eyes 103g′.

The locking spring 103o is suspended between the two spring arms 103g and presses the spring arms 103g against the side walls 103d, which form the stops. When the two actuating members 103i are pressed together the locking hooks 103h are moved inward and the lock is released.

FIGS. 17 to 21 show a second variant of the plug element 133a with an integrated carrier arm 133. The device is disposed in the space between the headrest 101d and the head restraint 101a and is fastened with the fastening means 105, 106 (FIG. 7) on the headrest bars 101b, 101.

The plug element 133a is inserted into the receiving bush 102a of the fastening means 105, 106 with the guide section 133f disposed at its front end and locked in the receiving bush 102a with both locking hooks 133h, which engage in the recesses 102f disposed on the side walls 102e of the receiving bush 102a (FIG. 2).

The step 133m at the rear end of the guide section 133f forms a limit stop for limiting the insertion depth of the plug element 133a and supports the plug element 133a at the front side wall 105c of the first fastening element 105.

The carrier arm 133 comprises the intermediate floor 133b′ which separates the plug element 133a into a lower receiving space 133q, in which a lower bearing rib 133e extending longitudinally is accommodated, and an upper receiving space 133q′ in which the locking mechanism 133g, 133h, 133i, 133o, 133g′, 133b″ as well as an upper bearing rib 133l extending longitudinally is accommodated. The bearing journals 133b″ disposed on the top side of the intermediate floor 133b′ form the rotating bearings for the bearing eyes 133g′ of the spring arms 133g.

The structure of the locking mechanism 133g, 133h, 133i, 133o, 133g′, 133b″ corresponds to the embodiment according to FIGS. 14 to 16.

The slightly lower bottom wall 111a of the carrier arm 133 is disposed at the rear end of the intermediate wall 133b′, with a rear wall 111a′ inclined toward the plug element, said rear wall 111a′ forming a entry inclination for hooking on objects, and a terminating wall 111b which is approximately perpendicular to the bottom wall 111a, at whose upper end a holding device 111c pointing toward the rear wall 111a′ is disposed, said holding device 111c being approximately flush with the upper rim 111a″ of the rear wall.

The lower bearing rib 133r extends centrally along the entire length of the carrier arm 133 and is connected to the underside of the intermediate floor 133b′, the rear wall 111a, the bottom wall 111a and the terminating wall 111b. The upper bearing rib 133l is disposed centrally on the top side of the intermediate floor 133b′ and extends from the front end of the intermediate wall 133b′ to the locking spring 133o.

An end wall 133l′ which is connected to the lower bearing rib 133r and the upper bearing rib 133l is disposed at the rear end of the intermediate floor 133b′.

A first centering rib 133r′ is disposed on the front end of the lower bearing rib 133r and a second centering rib 133r″, which is connected to the intermediate floor 133b′, is disposed behind the rear wall 111a′.

The two housing shells 133′, 133″ are plugged onto the carrier arm 133 from the side and join in the middle. Therein, the centering ribs 133r′, 133r″ grip into the positioning ribs 133d′, 133d″ disposed on the housing shells 133r, 133″, wherein the carrier arm 133 and the two housing shells 133′, 133″ are mutually aligned and fixed.

Cutouts 133s′, 133s″ are disposed on the side walls 133d of both housing shells 133′, 133″, said cutouts 133s′, 133s″ running congruently with the outside contours of the rear wall 111a′, the bottom wall 111a, the terminating wall 111b, and the holding device 111c of the carrier arm 133 and accommodate them, wherein the outside edges of the rear wall 111a′, the bottom wall 111a, the terminating wall 111b and the holding device 111c are flush with the outer sides of the side walls 133d and the top wall 133c of the housing shells 133′, 133″.

The plug element 133a, the carrier arm 133 and the housing shells 133′, 133″ jointly form a cuboid body, whose height approximately corresponds to the height of the fastening means 105, 106 (FIGS. 17 and 18).

1-22. (canceled)

23. A device for suspending objects on a vehicle seat part, a backrest, a head restraint or head restraint bars of a vehicle seat, the device comprising:
a fastening means for connecting the device to the vehicle seat part, said fastening means having a receiving bush;
a plug element structured for coupling to said receiving bush, said plug element having a housing and a guide section accommodated by said receiving bush;
a locking mechanism enclosed within said plug element housing, said locking mechanism disposed, structured and dimensioned to lock said plug element in said receiving bush, said locking mechanism having spring arms, wherein front ends of said spring arms define outwardly projecting locking hooks disposed on two sides of said guide section outside of said housing to engage in corresponding recesses defined in side walls of said receiving bush; and
a carrier arm disposed on said plug element and structured to suspend the objects.

24. The device of claim 23, wherein said guide section has a step which rests at sides of an opening of said receiving bush.

25. The device of claim 23, wherein actuating members which point outward are disposed on both said spring arms to protrude through switch openings in both side walls of said plug element and with which said spring arms are pressed toward each other to release said locking hooks.

26. The device of claim 23, wherein said spring arms are connected to said plug element at rear ends thereof by means of joints and pressed apart by a locking spring.

27. The device of claim 23, wherein said carrier arm has a bottom wall and an approximately vertically extending terminating wall disposed on a front end of said bottom wall, an upper end of said terminating wall defining a holding device which extends approximately parallel to said bottom wall and faces toward said plug element.

28. The device of claim 27, wherein said bottom wall has a rear wall which is inclined toward said plug element, said rear wall forming an entry inclination for hooking on objects.

29. The device of claim 28, wherein said holding device is approximately flush with an upper rim of said rear wall.

30. The device of claim 23, wherein said plug element is divided, by an intermediate floor, into an upper and a lower receiving space which lie one on top of an other and extend along a substantially entire length of said plug element.

31. The device of claim 30, wherein said intermediate floor is integral with or is permanently attached to said carrier arm.

32. The device of claim 30, wherein said carrier arm has at least one horizontally extending lower bearing rib disposed in said lower receiving space and said locking mechanism is accommodated in said upper receiving space, wherein an upper bearing rib extends in a longitudinal direction and is disposed on said carrier arm, centrally in said upper receiving space.

33. The device of claim 30, wherein bearing journals for supporting the spring arms are disposed on said intermediate floor.

34. The device of claim 23, wherein said carrier arm is made of metal and said housing is composed of at least two housing shells which are plugged onto said carrier arm from a side and join in a middle.

35. The device of claim 34, wherein centering ribs are disposed on said carrier arm, which correspond to positioning ribs on said housing shells to mutually align and fix said housing shells and said carrier arm.

36. The device of claim 34, wherein, on side walls of both said housing shells, cutouts are provided which are disposed in alignment with outside contours of a rear wall, a bottom wall, a terminating wall, and a holding device of said carrier arm to accommodate same, wherein outer edges of said rear wall, said bottom wall, said terminating wall and said holding device are approximately flush with outer sides of said side walls and a top wall of a corresponding said housing shell.

37. The device of claim 23, wherein said plug element, said carrier arm and said housing cooperate to form an approximately cuboid body, having a height substantially corresponding to a height of said fastening means.

38. The device of claim 23, wherein at least two of said plug element, said carrier arm, said locking mechanism and said housing together form a single component.
